(19) United States
(12) Patent Application Publication
(10) Pub. No.: US 2020/0186776 A1
(43) Pub. Date: Jun. 11, 2020

(54) IMAGE PROCESSING SYSTEM AND IMAGE PROCESSING METHOD

(71) Applicant: HTC Corporation, Taoyuan City (TW)

(72) Inventors: Hsiao-Tsung WANG, Taoyuan City (TW); Cheng-Yuan SHIH, Taoyuan City (TW); Hung-Yi YANG, Taoyuan City (TW)

(73) Assignee: HTC Corporation, Taoyuan City (TW)

(21) Appl. No.: 16/684,268

(22) Filed: Nov. 14, 2019

Related U.S. Application Data
(60) Provisional application No. 62/760,920, filed on Nov. 14, 2018.

(51) Int. Cl. H04N 13/128; H04N 13/122; H04N 13/344

(52) U.S. Cl. CPC H04N 13/128; H04N 2013/0081; H04N 13/344; H04N 13/122

(57) ABSTRACT

An image processing method includes the following steps: generating a current depth map and a current confidence map, wherein the current confidence map comprises the confidence value of each pixel; receiving a previous camera pose corresponding to a previous position, wherein the previous position corresponds to a first depth map and a first confidence map; mapping at least one pixel position of the first depth map to at least one pixel position of the current depth map according to the previous camera pose and the current camera pose of the current position; selecting the one with the highest confidence value after the confidence value of at least one pixel of the first confidence map is compared with the corresponding confidence value of the pixel of the current confidence map; and generating an optimized depth map of the current position according to the pixels corresponding to the highest confidence value.

### CROSS REFERENCE TO RELATED APPLICATIONS

This application claims the benefit of U.S. Provisional Application No. 62/760,920, filed Nov. 14, 2018, the entirety of which is incorporated by reference herein.

### BACKGROUND OF THE INVENTION

### Field of the Invention

The present disclosure relates to a processing system and, in particular, to an image processing system and an image processing method.

### Description of the Related Art

In general, dual camera lenses are often used to construct disparity maps for depth estimation. The main concept of depth estimation is matching corresponding pixels in different field-of-view (FOV) images of a dual camera lens. However, pixels in low-textured surfaces do not have obvious matching features, which results in unstable matching results in depth estimation. On the other hand, in a low light source environment, the processor needs to increase the brightness gain to maintain the brightness of the output image. However, the higher brightness gains may cause noise in the output image, which results in unstable depth estimates and reduced reliability. The lower confidence depth estimation can affect the quality of subsequent applications, Depth estimation can be applied in virtual reality or augmented reality, such as three-dimensional (3D) reconstruction of objects or environments. Although longer exposure times or noise suppression can alleviate the problem, these methods can also cause other imaging problems, such as motion blur or loss of detail in the image. The existing dual-camera multi-view method can maintain the temporal consistency of parallax, but the large and complicated processing process requires a lot of calculations.

Therefore, how to improve the quality and stability of the depth map, especially in areas with low texture or noise in the image, has become one of the problems to be solved in the art.

### BRIEF SUMMARY OF THE INVENTION

In accordance with one feature of the present invention, the present disclosure provides an image processing system. The image processing system includes a camera module and a processor. The camera module includes a first camera lens and a second camera lens. The first camera lens is configured to capture a first field-of-view (FOV) image at a current position. The second camera lens is configured to capture a second FOV image at the current position. The processor is configured to generate a current depth map and a current confidence map according to the first FOV image and the second FOV image, wherein the current confidence map comprises the confidence value of each pixel, the processor receives a previous camera pose corresponding to a previous position, the previous position corresponding to a first depth map and a first confidence map, the processor maps at least one pixel position of the first depth map to at least one pixel position of the current depth map according to the previous camera pose and the current camera pose of the current position, the processor selects the one with the highest confidence value after the confidence value of at least one pixel of the first confidence map is compared with the corresponding confidence value of the pixel of the current confidence map, and the processor generates an optimized depth map for the current position according to the pixels corresponding to the highest confidence value.

In accordance with one feature of the present invention, the present disclosure provides an image processing method. The image processing method comprises: capturing a first field-of-view (FOV) image at a current position using a first camera lens; capturing a second FOV image at a current position using a second camera lens; generating a current depth map and a current confidence map according to the first FOV image and the second FOV image, wherein the current confidence map comprises the confidence value of each pixel; receiving a previous camera pose corresponding to a previous position, the previous position corresponding to a first depth map and a first confidence map; mapping at least one pixel position of the first depth map to at least one pixel position of the current depth map according to the previous camera pose and the current camera pose of the current position; selecting the one with the highest confidence value after the confidence value of at least one pixel of the first confidence map is compared with the corresponding confidence value of the pixel of the current confidence map; and generating an optimized depth map of the current position according to the pixels that correspond to the highest confidence value.

In summary, the embodiments of the present invention provide an image processing system and an image processing method, which can enable a camera module to refer to the confidence value of each element in the current image and the previous images when shooting a low-textured object or a low-light source environment. The present invention provide an image processing system and an image processing method can generate the optimized depth information of the current image and can achieve the effect of applying the optimized depth information of the current image to produce a more accurate three-dimensional image.

### BRIEF DESCRIPTION OF THE DRAWINGS

The invention can be more fully understood by reading the subsequent detailed description and examples with references made to the accompanying drawings, wherein:

FIG. 1 is a schematic diagram of an image processing system in accordance with one embodiment of the present disclosure.

FIG. 2 is a flowchart of an image processing system in accordance with one embodiment of the present disclosure.

FIG. 3 is a schematic diagram of confidence values in accordance with one embodiment of the present disclosure.

FIG. 4 is a schematic diagram of an image processing method 400 in accordance with one embodiment of the present disclosure.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The present invention will be described with respect to particular embodiments and with reference to certain drawings, but the invention is not limited thereto and is only limited by the claims. It will be further understood that the terms “comprises,” “comprising,” “comprises” and/or “including,” when used herein, specify the presence of stated features, integers, steps, operations, elements, and/or components, but do not preclude the presence or addition of one or more other features, integers, steps, operations, elements, components, and/or groups thereof.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

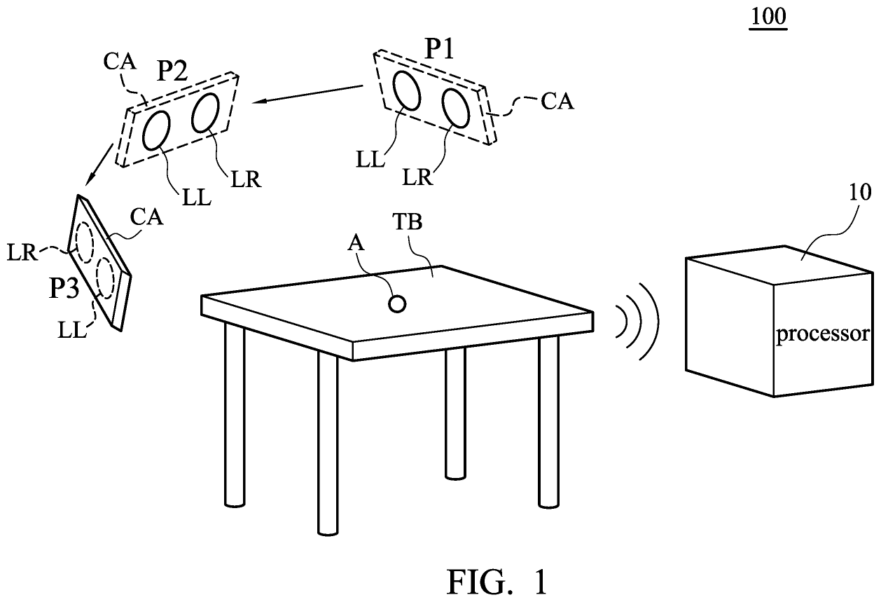

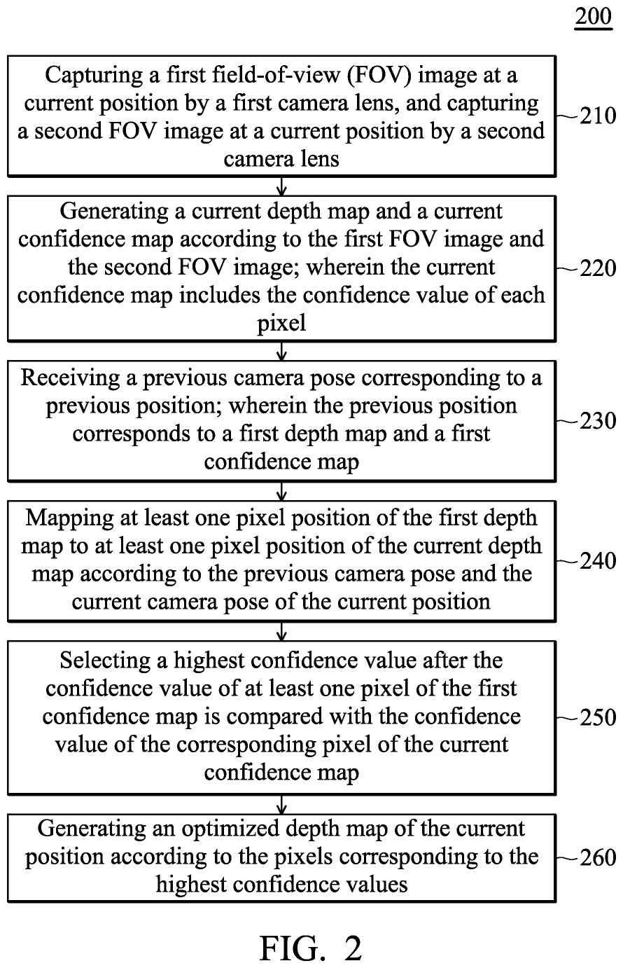

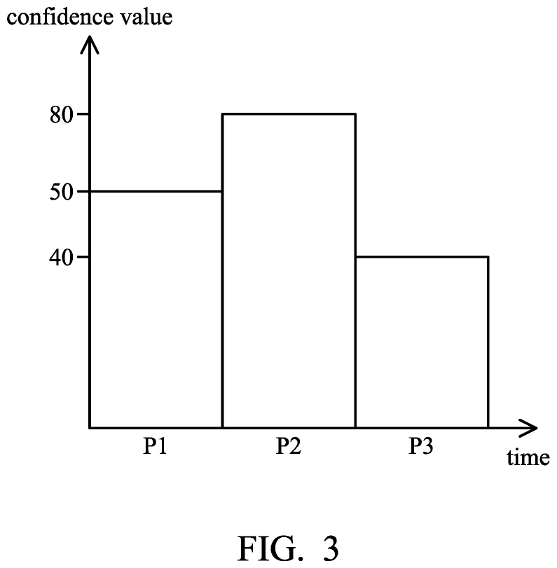

Please refer to FIGS. 1-3, FIG. 1 is a schematic diagram of an image processing system 100 in accordance with one embodiment of the present disclosure. FIG. 2 is a flowchart of an image processing system 200 in accordance with one embodiment of the present disclosure. FIG. 3 is a schematic diagram of confidence values in accordance with one embodiment of the present disclosure.

In one embodiment, the image processing system 100 includes a camera module CA and a processor 10. The images can be transmitted between camera module CA and the processor 10 through a wireless or wired method. The camera module CA includes a camera lens LR and a camera lens LL. In one embodiment, the camera module CA is a dual-lens camera module. In one embodiment, the camera lens LR is a right-eye camera lens. When the camera module CA shoots to point A on the desktop TB, the field-of-view (FOV) image captured by the camera lens LR is a right-eye image. And, the camera lens LL is a left-eye camera lens. When the camera module CA shoots to point A on the desktop TB, the FOV image captured by the camera lens LL is a left-eye image.

In one embodiment, the camera module CA can be disposed in a head-mounted device to capture images as the user's head moves.

In one embodiment, as shown in FIG. 1, the camera module CA can continuously capture images at different positions and sequentially store the images in an image queue. For example, the camera module CA shoots at position P1 toward point A. The camera module CA captures the right-eye image and the left-eye image at position P1, and the camera module CA transmits the right-eye image and the left-eye image at position P1 to the processor 10. The processor 10 stores the right-eye image and the left-eye image in the image queue. Then, the camera module CA shoots at position P2 toward point A. The camera module CA captures the right-eye image and the left-eye image at position P2, and the camera module CA transmits the right-eye image and the left-eye image at position P2 to the processor 10. The processor 10 stores the right-eye image and the left-eye image in the image queue. Finally, the camera module CA shoots at position P3 toward point A. The camera module CA captures the right-eye image and the left-eye image at position P3, and the camera module CA transmits the right-eye image and the left-eye image at position P3 to the processor 10. The processor 10 stores the right-eye image and the left-eye image in the image queue.

In one embodiment, the process of moving the camera module CA from position P1 through position P2 to position P3 can be a continuous action, and continuous shooting can be performed for capturing images of the A point. For the convenience of description, the present invention takes three shots: That is, one shot at each of positions P1, P2, and P3, for example. A set of right-eye and left-eye images is obtained with each shot. However, a person having ordinary knowledge in the art should understand that during the process of moving the camera module CA from position P1 to position P3, multiple shots can be taken, and the number of shots is not limited.

In an embodiment, the point A captured by the camera module CA may be a low-textured object or a low-light source (or noisy) environment. In addition, low-texture objects are, for example, smooth desktops, spheres, or mirrors. The characteristics of these objects are too smooth or the characteristics are unclear. The captured images will have a reflective effect, so that it will cause the captured images unclear. It is difficult for the processor 10 to compare the parallax of the right-eye image and the left-eye image. The low light environment will cause too much noise in the captured image, and the brightness of the image needs to be brightened in order to compare the parallax of the right-eye image and the left-eye image.

In one embodiment, the depth of each pixel can be estimated by using the parallax of the corresponding pixels in the right-eye image and the left-eye image to generate a depth map.

More specifically, when the camera module CA shoots a low-texture object or a low-light environment, the captured image has lower confidence values. The confidence value represents the degree of similarity of the corresponding pixels in the right-eye image and the left-eye image. For example, the degree of similarity between the top-right pixel of the right-eye image and the top-right pixel of the left-eye image. The set (that is, every pixel in the right-eye image and every pixel in the left-eye image) of all degrees of similarity is called a confidence map.

The processor 10 can apply a known matching cost algorithm to calculate the confidence value. For example, the matching cost distribution algorithm uses the corresponding absolute intensity differences in the right-eye image and the left-eye image as matching costs, and considers these comparison costs as the confidence values of the corresponding pixels in the right-eye image and the left-eye image. In other words, each pixel of the right-eye image and its corresponding pixel of the left-eye image correspond to a confidence value. The matching cost distribution algorithm is a well-known algorithm, so it will not be described herein.

As shown in FIG. 3, for example, during the process of moving the camera module CA from position P1 through position P2 to position P3, three images were sequentially shot for point A (the shooting time is in the order of moving to the positions P1, P2, and P3). For example, the confidence value between the pixel in the upper-right corner of the right-eye image and the pixel in the upper-right corner of the left-eye image taken at position P1 is 50. For example, the confidence value between the pixel in the upper-right corner of the right-eye image and the pixel in the upper-right corner of the left-eye image captured at position P2 is 80. For example, the confidence value between the pixel in the upper-right corner of the right-eye image and the pixel in the upper-right corner of the left-eye image captured at position P3 is 30. The numerical method of confidence value can also be expressed in other ways, such as percentage, or converted to a value between 0 and 1, which is not limited thereto.

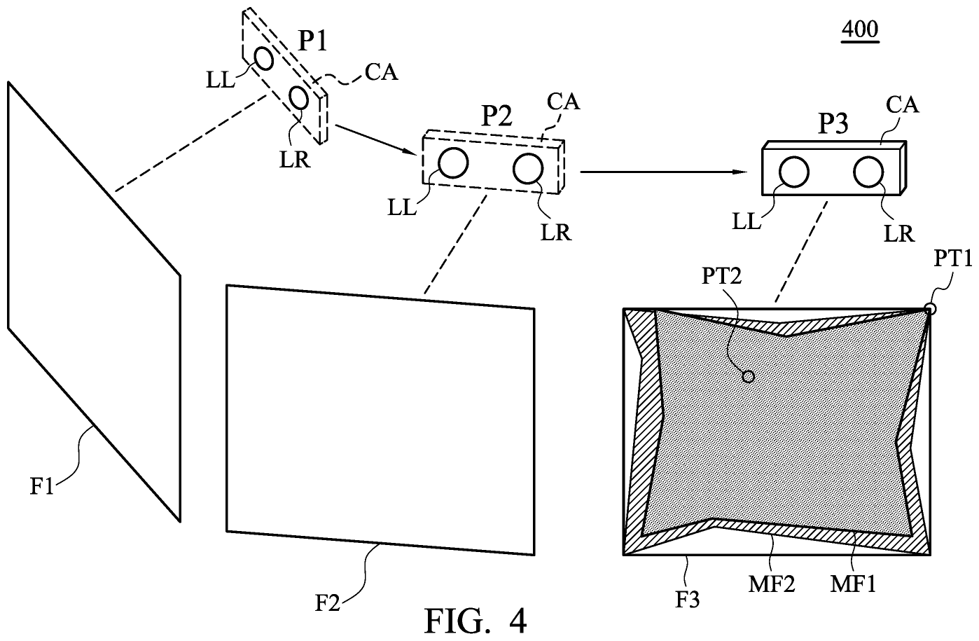

It can be seen that when the camera module CA shoots a low-texture object or a low-light source environment, the captured image is likely to cause inconspicuous gray levels due to reflections or low-light sources, which makes the confidence value calculated by the processor 10 unstable. Therefore, the present invention addresses this situation by referring to previous images to generate optimized depth information of the current image. Please refer to FIGS. 1 to 4 together. FIG. 4 is a schematic diagram of an image processing method 400 in accordance with one embodiment of the present disclosure. The image processing method 200 in FIG. 2 further describes each step.

In step 210, a first camera lens captures a first field-of-view (FOV) image at a current position, and a second camera lens captures a second FOV image at the current position.

In one embodiment, as shown in FIG. 1, when the camera module CA is located at the current position P3, the camera lens LR captures a right-eye image (that is, a first FOV image), and the camera lens LL captures a left-eye image (that is, a second FOV image).

In step 220, a processor generates a current depth map and a current confidence map according to the first FOV image and the second FOV image, and the current confidence map includes the confidence value of each pixel.

In one embodiment, the processor 10 generates a current depth map according to the right-eye image and the left-eye image captured when the camera module CA is located at the current position P3. The processor 10 applies a known algorithm to generate a current depth map, such as a stereo matching algorithm.

In one embodiment, the processor 10 applies a known comparison cost distribution algorithm to calculate the confidence value. The confidence value represents the degree of similarity of the corresponding pixels in the right-eye image and the left-eye image. The set (that is, every pixel in the right-eye image and every pixel in the left-eye image) of all degrees of similarity is called a confidence map.

In step 230, the processor 10 receives a previous camera pose corresponding to a previous position, and the previous position corresponds to a first depth map and a first confidence map.

In one embodiment, the previous camera pose is provided by a tracking system. In one embodiment, the tracking system can be located inside or outside the image processing system 100. In one embodiment, the tracking system can be an inside-out tracking system, an outside-in tracking system, a lighthouse tracking system, or other tracking systems that can provide camera pose.

In one embodiment, the previous camera pose can be calculated by the camera module CA when shooting at position P1 (previous position). In addition, when the camera module CA is shooting at position P1, the processor 10 can also firstly calculate the first depth map and the first confidence map. Therefore, position P1 (the previous position) has a corresponding depth map and a corresponding confidence map.

In one embodiment, the camera module CA sequentially shoots at positions P1-P3. Therefore, when the camera module CA is shooting at the current position P3, it means that the camera module CA has completed shooting at the positions P1 to P2. And, the processor 10 has generated a depth map and a confidence map corresponding to the positions P1 to P2, respectively. Also, the camera module CA's camera pose at the positions P1 to P2 has been recorded, respectively.

In one embodiment, the camera module CA firstly shoots an object (for example, point A) or an environment at position P1. The processor 10 generates a depth map and a confidence map corresponding to position P1, and records the confidence value of each pixel in the confidence map in a confidence value queue. The camera module CA then shoots the object at position P2. The processor 10 generates a depth map and a confidence map corresponding to position P2, and records the confidence value of each pixel in the confidence map in the confidence value queue. Finally, the camera module CA shoots the object at the current position P3, and the processor 10 records the confidence value of each pixel in the current confidence map in the confidence value queue.

In this example, the queue can record three confidence maps. Therefore, when the first confidence map is generated, the first confidence map is stored in the confidence value queue. When the second confidence map is generated, the first confidence map and the second confidence map are stored in the confidence value queue. When the third confidence map is generated, the first confidence map, the second confidence map, and the third confidence map are stored in the confidence value queue. When the fourth confidence map is generated, the second confidence map, the third confidence map, and the fourth confidence map are stored in the confidence value queue. This represents the current depth map generated based on the current position, which can refer to the confidence map generated by the previous two shots. For example, when shooting at the current position P3, the current depth map can be generated referring to the confidence map generated by shooting at the positions P1 and P2. For another example, when shooting at the current position P4, the current depth map can be generated referring to the confidence map generated by shooting at the positions P2 and P3.

In one embodiment, the processor 10 receives the camera pose of the camera module CA at position P1 (i.e., the previous position), and calculates a depth map and a confidence map corresponding to position P1. In one embodiment, the processor 10 generates a depth map and a confidence map according to the right-eye image and the left-eye image captured when the camera module CA is located at position P1. In one embodiment, the camera pose of the camera module CA can be expressed by a rotation degree and a translation distance. In an embodiment, the camera module CA can obtain the camera pose of the camera module CA in an environmental space through an external tracking system, such as lighthouse technology. The external tracking system can transmit the camera pose of the camera module CA to the processor 10 through a wired or wireless manner.

In step 240, the processor 10 maps at least one pixel position of the first depth map to at least one pixel position of the current depth map according to the previous camera pose and the current camera pose of the current position.

In one embodiment, referring to FIG. 4, the processor 10 attempts to shift or rotate the depth map F1 corresponding to position P1. More specifically, the processor 10 calculates a rotation and translation matrix by means of a conversion formula for calculating a rotation and a translation according to the camera pose of the camera module CA at position P1 (that is, the previous camera pose) and the camera pose of the camera module CA at the current position P3 (that is, the current camera pose). At least one pixel position of the depth map F1 is mapped to at least one pixel position of the current depth map F3 by the rotation and translation matrix. A known mathematical calculation method can be applied to calculate the rotation and translation matrix, so it will not be further described here. In one embodiment, the processor 10 maps the pixel PT1 at the top right corner of the depth map F1 to the pixel PT1 at the top right corner of the current depth map F3. Since the shooting position corresponding to the depth map F1, the camera pose of the camera module CA at position P1 (that is, the previous camera pose) are different from the current shooting position corresponding to the depth map F3 and the camera pose of the camera module CA at position P3 (that is, the current camera pose), when all pixels in the depth map F1 are mapped to the current depth map, the depth map F1 may generate a mapped depth map MF1 with deformation.

In one embodiment, after the processor 10 obtains the depth map F2 corresponding to position P2, the processor 10 attempts to shift or rotate the depth map F2 corresponding to position P2. More specifically, the processor 10 calculates a rotation and translation matrix by means of a conversion formula for calculating a rotation and a translation according to the camera pose of the camera module CA at position P2 (that is, the other previous camera pose) and the camera pose of the camera module CA at the current position P3 (that is, the current camera pose). At least one pixel position of the depth map F2 is mapped to at least one pixel position of the current depth map F3 by the rotation and translation matrix. In one embodiment, the processor 10 maps the pixel PT1 at the top right corner of the depth map F2 to the pixel PT1 at the top right corner of the current depth map F3. Since the shooting position corresponding to the depth map F2, the camera pose of the camera module CA at position P2 (that is, the other previous camera pose) are different from the current shooting position corresponding to the depth map F3 and the camera pose of the camera module CA at position P3 (that is, the current camera pose), when all pixels in the depth map F2 are mapped to the current depth map, the depth map F2 may generate a mapped depth map MF2 with deformation.

In step 250, the processor 10 selects a highest confidence value after the confidence value of at least one pixel of the first confidence map is compared with the confidence value of the corresponding pixel of the current confidence map.

In one embodiment, after the mapped depth maps MF1 and MF2 are generated, the processor 10 can obtain that each pixel in the mapped depth maps MF1 and MF2 maps to each pixel position of the current depth map F3. For at least one pixel (for example, pixel PT1) in the current depth map F3, the processor 10 selects the highest confidence value from the confidence value queue. By comparing the confidence value of at least one pixel in the confidence map corresponding to position P1 and the confidence value of at least one pixel in the confidence map corresponding to position P2 are respectively with corresponding confidence value of the pixel of the current confidence map, the processor 10 may select the confidence value.

In one embodiment, after the mapped depth maps MF1 and MF2 are generated, the processor 10 can know that each pixel in the mapped depth maps MF1 and MF2 maps to each pixel position of the current depth map F3 (for example, the pixel in the top right corner of the mapped depth maps MF1 and MF2 and the current depth map F3 all correspond to the pixel PT1). For each pixel, the processor 10 selects the one having the highest confidence value as the output. For example, as shown in FIG. 3, the confidence value of the top right pixel PT1 of the mapped depth map MF1 after mapping is 50, and the confidence value of the top right pixel PT1 of the mapped depth map MF2 after mapping is 80. The confidence value of the top right pixel PT1 of the current depth map F3 after mapping is 30. Since the confidence value of the pixel PT1 at the top right corner of the current depth map F3 is the lowest, it means that when the camera module CA shoots point A at position P3, the image may be unclear due to the shooting pose of position P3. Therefore, the processor 10 selects the depth of the pixel PT1 in the top right corner of the depth map F2 with the highest confidence value for the pixel PT1 as an output.

In step 260, the processor 10 generates an optimized depth map of the current position according to the pixels corresponding to the highest confidence values.

In one embodiment, the processor 10 compares each pixel in the current depth map F3 with the mapped depth maps MF1 and MF2 and individually selects the pixel corresponding to the highest confidence value as the output. For example, the processor 10 selects the pixel PT1 in the top right corner of the depth map F2 with the highest confidence value as the output for the pixel PT1 of the current depth map F3. In addition, if the confidence value of the pixel PT2 of the mapped depth map MF1 is 70, the confidence value of the pixel PT2 of the mapped depth map MF2 is 40, and the confidence value of the pixel PT2 of the current depth map F3 is 30, the processor 20 will select the pixel corresponding to the highest confidence value for the pixel PT2 of the current depth map F3. That is, the depth corresponding to the pixel PT2 of the depth map F1 is used as an output (assuming that the pixel PT2 in the current depth map F3 corresponds to the pixel PT2 respectively in the mapped depth maps MF1 and MF2). For the part that does not correspond to the depth maps MF1 and MF2, the processor 10 uses the depth corresponding to the pixels of the current depth map F3 as an output. After the processor 10 completes the comparison of each pixel in the current depth map F3 and selects the output depth corresponding to each pixel, the entire depth of all the outputs is regarded as an optimized depth map.

In summary, the embodiments of the present invention provide an image processing system and an image processing method, which can enable a camera module to refer to the confidence value of each element in the current image and the previous images when shooting a low-textured object or a low-light source environment. The present invention provide an image processing system and an image processing method can generate the optimized depth information of the current image and can achieve the effect of applying the optimized depth information of the current image to produce a more accurate three-dimensional image.

Although the invention has been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such a feature may be combined with one or more other features of the other implementations as may be desired and advantageous for any given or particular application.

What is claimed is:

1. An image processing system, comprising:
a camera module, comprising:
a first camera lens, configured to capture a first field-of-view (FOV) image at a current position;
a second camera lens, configured to capture a second FOV image at the current position; and
a processor, configured to generate a current depth map and a current confidence map according to the first FOV image and the second FOV image, wherein the current confidence map comprises a confidence value for each pixel, and the processor performs:
receiving a previous camera pose corresponding to a previous position, wherein the previous position is corresponding to a first depth map and a first confidence map;
mapping at least one pixel position of the first depth map to at least one pixel position of the current depth map according to the previous camera pose and a current camera pose of the current position;
selecting a highest confidence value after the confidence value of at least one pixel of the first confidence map is compared with the confidence value of the corresponding at least one pixel of the current confidence map; and
generating an optimized depth map of the current position according to the pixels corresponding to the highest confidence values.

2. The image processing system of claim 1, wherein the first camera lens is a left-eye camera lens, the first FOV image is a left-eye image, the second camera lens is a right-eye camera lens, and the second FOV image is a right-eye image.

3. The image processing system of claim 1, wherein the processor maps the at least one pixel position of the first depth map to the at least one pixel position of the current depth map according to the previous camera pose and the current camera pose of the current position, by means of a conversion formula for calculating a rotation and a translation.

4. The image processing system of claim 1, wherein the processor generates the current confidence map by calculating a degree of similarity of each pixel in the first FOV image and each corresponding pixel in the second FOV image according to a matching cost algorithm.

5. The image processing system of claim 1, wherein the camera module captures an object or an environment at the previous position, the processor generates the first depth map and the first confidence map corresponding to the previous position, the processor records the confidence value of each pixel in the first confidence map in a queue, the camera module captures the object at another previous position, the processor generates a second depth map and a second confidence map corresponding to the other previous position, the processor records the confidence value of each pixel in the second confidence map in the queue, the camera module captures the object at the current position, and the processor records the confidence value of each pixel in the current confidence map in the queue.

6. The image processing system of claim 5, wherein the processor selects the highest confidence value from the queue after a confidence value of at least one pixel of the first confidence map and a confidence value of at least one pixel of the second confidence map are respectively compared with the corresponding confidence value of the at least one pixel of the current confidence map, and the processor generates the optimized depth map of the current position according to the pixels corresponding to the highest confidence value.

7. The image processing system of claim 5, wherein the processor receives another previous camera pose corresponding to the other previous position, and calculates the second depth map corresponding to the other previous position, the processor maps at least one pixel position of the second depth map to the at least one pixel position of the current depth map according to the other previous camera pose and the current camera pose of the current position, by means of a conversion formula for calculating a rotation and a translation.

8. An image processing method, comprising:
capturing a first field-of-view (FOV) image at a current position using a first camera lens;
capturing a second FOV image at a current position using a second camera lens;
generating a current depth map and a current confidence map according to the first FOV image and the second FOV image, wherein the current confidence map comprises the confidence value of each pixel;
receiving a previous camera pose corresponding to a previous position; wherein the previous position corresponds to a first depth map and a first confidence map;
mapping at least one pixel position of the first depth map to at least one pixel position of the current depth map according to the previous camera pose and the current camera pose of the current position;
selecting a highest confidence value after the confidence value of at least one pixel of the first confidence map is compared with the confidence value of the corresponding at least one pixel of the current confidence map; and
generating an optimized depth map of the current position according to the pixels corresponding to the highest confidence values.

9. The image processing method of claim 8, wherein the first camera lens is a left-eye camera lens, the first FOV image is a left-eye image, the second camera lens is a right-eye camera lens, and the second FOV image is a right-eye image.

10. The image processing method of claim 8, further comprising:
mapping the at least one pixel position of the first depth map to the at least one pixel position of the current depth map according to the previous camera pose and the current camera pose of the current position, by means of a conversion formula for calculating a rotation and a translation.

11. The image processing method of claim 8, further comprising:
generating the current confidence map by calculating a degree of similarity of each pixel in the first FOV image and each corresponding pixel in the second FOV image according to a matching cost algorithm.

12. The image processing method of claim 8, further comprising:
capturing an object or an environment at the previous position by the camera module;
generating a first depth map and a first confidence map corresponding to the previous position,
recording the confidence value of each pixel in the first confidence map in a queue;
capturing the object at another previous position;
generating a second depth map and a second confidence map corresponding to the other previous position;
recording the confidence value of each pixel in the second confidence map in the queue;
capturing the object at the current position; and
recording the confidence value of each pixel in the current confidence map in the queue.

13. The image processing method of claim 12, further comprising:
selecting the highest confidence value from the queue after the confidence value of at least one pixel of the first confidence map and the confidence value of at least one pixel of the second confidence map are respectively compared with the corresponding confidence value of the at least one pixel of the current confidence map; and
generating an optimized depth map of the current position according to the pixels corresponding to the highest confidence value.

14. The image processing method of claim 12, further comprising:
receiving another previous camera pose corresponding to the other previous position;
calculating the second depth map corresponding to the other previous position; and
mapping at least one pixel position of the second depth map to the at least one pixel position of the current depth map according to the other previous camera pose and the current camera pose of the current position, by means of a conversion formula for calculating a rotation and a translation.
